(19) United States
(12) Patent Application Publication
(10) Pub. No.: US 2006/0001899 A1
(43) Pub. Date: Jan. 5, 2006

(54) Method and apparatus for image processing

(75) Inventor: Hiroshi Kanno, Amagasaki-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/150,520

(22) Filed: Jun. 9, 2005

(30) Foreign Application Priority Data
Jun. 9, 2004 (JP) 2004-171775

(51) Int. Cl. G06F 15/00

(52) U.S. Cl. 358/1.14

(57) ABSTRACT

An image processing method is provided comprising the steps of receiving image data and reference data for processing the image data at an image processing apparatus and processing the image data in response to the reference data. In particular, the method involves judging a level of secrecy of the image data from the reference data, determining an process to be executed on the basis of a result of the judgment, and executing the process.

### CROSS-REFERENCE TO RELATED APPLICATIONS

This Nonprovisional application claims priority under 35 U.S.C. $119(a) on Patent Application No. 2004-171775 filed in Japan on Jun. 9, 2004, the entire contents of which are hereby incorporated by reference.

### BACKGROUND OF THE INVENTION

1. Field of the Invention

The present invention relates to a method and an apparatus for image processing to provide a user with security environments pertinent to the user.

2. Description of Related Art

An image processing apparatus is known having an electronic filing function for reading an image data by optically scanning an original, temporarily saving the image data in a recording medium, and reading again the image data of the original from the recording medium a number of times which is equal to a desired number of copies for printing out the image data on sheets of copy paper (For example, see Japanese Patent Laid-Open No. 06-178041).

It is common for such conventional image processing apparatuses with the electronic filing function to have a file allocation table (FAT) arranged for determining the location of storage on the recording medium where any image data is to be saved or identifying the location of storage from which desired image is read out. FAT assigns each image data to be saved on the recording medium with its data number and its reference value is specified by the data number to allocate the image data at its storage location on the recording medium.

FAT is updated whenever the action of printing out each desired image data has been completed. When FAT is deleted or updated, its assigning image data can not be read out from the recording medium by the action of the image data processing apparatus. Accordingly, the use of FAT allows any data to be protected from false access thus ensuring the security of image data.

However, as relevant technologies for the data processing have been advanced and spread out, they may permit any false third party to remove the recording medium (for example, a hard disk drive) from the image processing apparatus where image data remain saved but not perfectly erased with the deletion or updating of FAT and thus illegally read any desired image data from the recording medium.

Some modifications are proposed for protecting the image data from unauthorized leakage or use.

The modifications include an image processing apparatus (disclosed in Japanese Patent Laid-Open Publication No. 07-28365) where the protection is based on identification of each individual user, another image processing apparatus (disclosed in Japanese Patent Laid-Open Publication 2000-187419) where each image data to be read is accompanied with its pertinent information which is traceable, a further image processing apparatus (disclosed in Japanese Patent Laid-Open Publication No. 01-256068) where each image data is encrypted before saved on a recording medium, and a still further image processing apparatus (disclosed in Japanese Patent Laid-Open Publication No. 09-223061) where each image data saved on a recording medium is automatically erased upon its necessity being canceled. The modifications are capable of inhibiting unauthorized leakage or use of image data stored on the image processing apparatus.

However, those modifications may fail to protect the image data from being leaked or illegally used because they need initial setting of their actions which is a troublesome task and has to be conducted without errors by every user controlling the printer driver or operating panel of the image processing apparatus.

Also, since the processes of the conventional image processing apparatuses are analogous, they allow some of the image data at no secrecy to be encrypted or each of the image data to be systematically erased and will thus consume more time resulting in the slowdown.

### BRIEF SUMMARY OF THE INVENTION

The present invention has been developed in view of the above aspects and its object is to provide a method and an apparatus for image processing where the process involves receiving an image data and one or more reference data to be cited for processing the image data, examining the level of secrecy of the image data from the reference data, determining an process to be carried out from a result of the examination, and carrying out the determined process, so that the security environment depending on the conditions of use can be established without declining the efficiency of the process.

An image processing method according to the present invention is characterized by the steps of receiving image data and reference data for processing the image data, judging a level of secrecy of the image data to be processed, on the basis of the received reference data, determining a process to be executed on the basis of a result of the judgment, and executing the process.

In the present invention, the method comprises the steps of receiving an image data and one or more reference data to be cited for processing the image data, examining the level of secrecy of the image data from the reference data, determining an process to be executed from a result of the examination, and executing the determined process. As a result, the process is varied between the high level of secrecy and the low level of secrecy. Accordingly, the secrecy of the image data can be protected without declining the processing efficiency.

An image processing apparatus according to the present invention is characterized by comprising means for receiving image data and reference data for processing the image data, means for judging a level of secrecy of the image data to be processed, on the basis of the received reference data, means for determining a process to be executed on the basis of a result of the judgment, and means for executing the process.

The image processing apparatus is arranged for receiving an image data and one or more reference data to be cited for processing the image data, examining the level of secrecy of the image data from the reference data, determining an process to be executed from a result of the examination, and executing the determined process. As a result, the process is varied between the high level of secrecy and the low level of secrecy. Accordingly, the secrecy of the image data can be protected without declining the processing efficiency.

An image processing apparatus according to the present invention is characterized by comprising means for receiving image data and reference data for processing the image data, means for judging the level of secrecy of the image data on the basis of the received image data and reference data, means for determining a process to be executed on the basis of a result of the judgment, and means for executing the process.

The image processing apparatus is arranged for receiving an image data and one or more reference data to be cited for processing the image data, examining the level of secrecy of the image data from a combination of the image data and the reference data, determining an process to be executed from a result of the examination, and executing the determined process. As a result, the process is varied between the high level of secrecy and the low level of secrecy. Accordingly, the secrecy of the image data can be protected without declining the processing efficiency.

The image processing apparatus according to the present invention is characterized in that the reference data indicates whether or not image data is encrypted.

Since the reference data indicates whether the image data is encrypted or not, the level of secrecy is judged to be high when the image data is encrypted and thus the process can be executed so as to protect the secrecy. When the image data is not encrypted, the process can be conducted with no protection of the secrecy.

The image processing apparatus according to the present invention is characterized by comprising means for combining the received image data with prescribed image data, and wherein the reference data indicates whether or not the image data is to be combined with the prescribed image data.

Since the reference data indicates whether or not the image data is combined with the additional image data, the level of secrecy is judged to be high when the image data is accompanied with a specific marking such as “confidential” or “important”, or a specific tint block pattern and the process can be executed so as to protect the secrecy. When the additional image data is not combined, the process can be conducted with no protection of the secrecy.

The image processing apparatus according to the present invention is characterized in that the reference data indicates information data about a user.

Since the reference data is a data about the user, the level of secrecy of the image data received from certain users is judged to be high and the process can be executed so as to protect the secrecy. The image data from other users can thus be protected with no level of secrecy.

The image processing apparatus according to the present invention is characterized in that, the invalidation process is executed on the image data, when it is judged that the level of secrecy of the image data is high.

Since the image data is invalidated when it is judged that the level of secrecy of the image data is high, it can be protected from being illegally accessed by and leaked to any dishonest third party.

The image processing apparatus according to the present invention is characterized in that, the encryption process is executed on the image data, when it is judged that the level of secrecy of the image data is high.

Since the image data is encrypted when it is judged that the level of secrecy of the image data is high, it can be protected from being decoded and read by any dishonest third party even after successfully intercepted.

The image processing apparatus according to the present invention is characterized by comprising means for receiving user data, and means for identifying a user from the received user data, wherein the process is paused until the user is identified, when it is judged that the level of secrecy of the image data is high.

Since the process is paused before the user is identified when it has been judged that the level of secrecy of the image data is high, the image data can be protected from being illegally accessed by and leaked to any dishonest third party.

As featured, the present invention involves receiving an image data and its reference data to be cited for processing the image data, examining the level of secrecy of the image data from the reference data, determining an process to be executed from a result of the examination, and executing out the determined process. As a result, the process is varied between the high level of secrecy and the low level of secrecy. Accordingly, the secrecy of the image data can be protected without declining the processing efficiency.

As featured, the present invention involves examining the level of secrecy of the image data to be processed from a combination of the image data and its reference data, determining an process to be executed from a result of the examination, and executing the determined process. As a result, the process is varied between the high level of secrecy and the low level of secrecy. Accordingly, the secrecy of the image data can be protected without declining the processing efficiency.

The present invention is featured in that the reference data indicates whether the image data is encrypted or not. Accordingly, when the image data is encrypted, it is judged to be high in the level of secrecy and can thus be processed so as to protect the secrecy. When the image data is not encrypted, it is judged to be low in the level of secrecy and can thus be processed with no protection of the secrecy. In other words, the secrecy remains protected without declining the efficiency of the process.

The present invention is featured in that the reference data indicates whether or not the image data is combined with an additional image data. Accordingly, the level of secrecy is judged to be high when the image data is accompanied with a specific marking such as “confidential” or “important”, or a tint block pattern and the process can be selected so as to protect the secrecy. When the additional image data is not combined, the action can be conducted with no protection of the secrecy. Therefore, the secrecy remains protected without declining the efficiency of the process.

The present invention is featured in that the reference data is a data about the user. Accordingly, when the level of secrecy of the image data received from certain user is judged to be high, the process can be selected so as to protect the secrecy. The image data from other users can thus be protected with no level of secrecy. In other words, the secrecy remains protected without declining the efficiency of the process.

The present invention is featured in that, when it is judged that the level of secrecy of the image data is high, the image data is invalidated. Accordingly, the image data can be protected from being illegally accessed by and leaked to any dishonest third party.

The present invention is featured in that, when it is judged that the level of secrecy of the image data is high, the image data is encrypted. Accordingly, the image data can be protected from being decoded and read by any dishonest third party even after successfully intercepted.

The present invention is featured in that, when it is judged that the level of secrecy of the image data is high, the action can be paused before the user is identified. Accordingly, the image data can be protected from being illegally accessed by and leaked to any dishonest third party.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram of the entire arrangement of an image processing system according to the present embodiment;

FIG. 2 is a schematic view showing an example of the print setting screen generated by the printer driver installed in the data processing terminal;

FIG. 3 is a schematic view showing an example of the option setting screen;

FIG. 4 is a concept view showing the detail of the print job generated by the printer driver;

FIG. 5 is a block diagram showing the internal structure of the image forming apparatus;

FIGS. 6A to 6E are diagrams showing an example of the security level calculating table stored in the management section;

FIG. 7 is a flowchart explaining the steps of a process to be executed by the image forming apparatus;

FIGS. 8A and 8B are explanatory diagrams explaining examples for calculating the security levels;

FIG. 9 is a diagram showing a list of the processes to be executed depends on the calculated security levels;

FIG. 10 is a flowchart explaining the steps of a process to be executed by the image forming apparatus; and

FIGS. 11A and 11B are explanatory diagrams explaining examples for calculating the security levels.

### DETAILED DESCRIPTION OF THE INVENTION

The present invention will be described in more detail referring to the accompanying drawings.

Embodiment 1

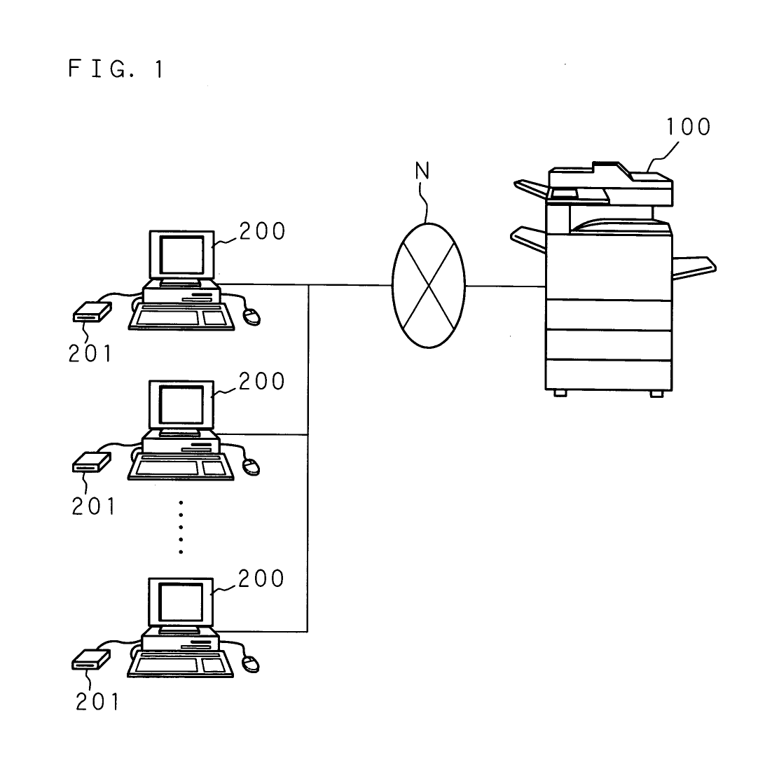

FIG. 1 is a block diagram of the entire arrangement of an image processing system according to the present embodiment. Denoted by 100 is an image forming apparatus which has a scanner function of reading the image of an original, a copy function of reproducing the image on a sheet of, e.g., paper or OHP film, and a print function of printing the image on the sheet according to a given printing job. The image forming apparatus 100 is connected by a communications network N to a group of data processing terminals 200 such as personal computers or work stations. The data processing terminal 200 has an application program installed for producing texts and graphics and a driver program (printer driver) installed for operating the image forming apparatus 100 over the communications network N. This allows the printer driver when read out and actuated to provide the image forming apparatus 100 with a printing job for printing down texts and graphics.

The data processing terminals 200 are accompanied with user identification peripherals 201 for identifying their users from the user authentication information including the name, the status, and the department of the users. For example, the user identification peripheral 201 incorporates a reader for reading the user authentication information, described above, from an IC card which is assigned to the individual user. The user authentication information received by the user identification peripheral 201 is used as one of the data attached to the printing job.

In this embodiment, the image forming apparatus 100 analyzes the printing job received over the communications network N to judge the level of secrecy of an image data to be handled and then executes the printing job according to the judgment.

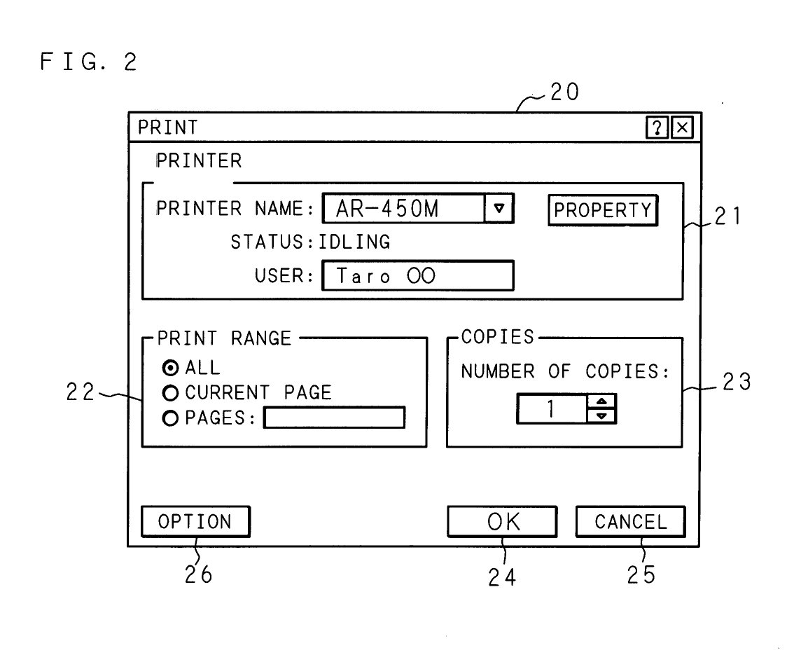

FIG. 2 is a schematic view showing an example of the print setting screen generated by the printer driver installed in the data processing terminal 200. The print setting screen 20 shown in FIG. 2 displays, at least, a printer selecting dialog box 21 for selecting a printer (the image forming apparatus) suited for carrying out the desired printing job, a print range specifying dialog box 22 for specifying the range of printing, and a prints number specifying dialog box 23 for determining the number of prints. The printer selecting dialog box 21 indicates the name of a printer selected by the user, the operation data of the selected printer, and the user authentication information entered by the user operating the user identification peripheral 201.

Also, the print setting screen 20 displays at the lower right an execution button 24 for determining the printing job from the setting data entered in the print setting screen 20 and transferring it to the selected printer (for example, the image forming apparatus 100) selected at the printer select dialog box 21 and a cancel button 25 for canceling the printing job and returning to the previous application for displaying the print setting screen 20. In addition, an option button 26 is provided at the lower left of the print setting screen 20 for setting any option.

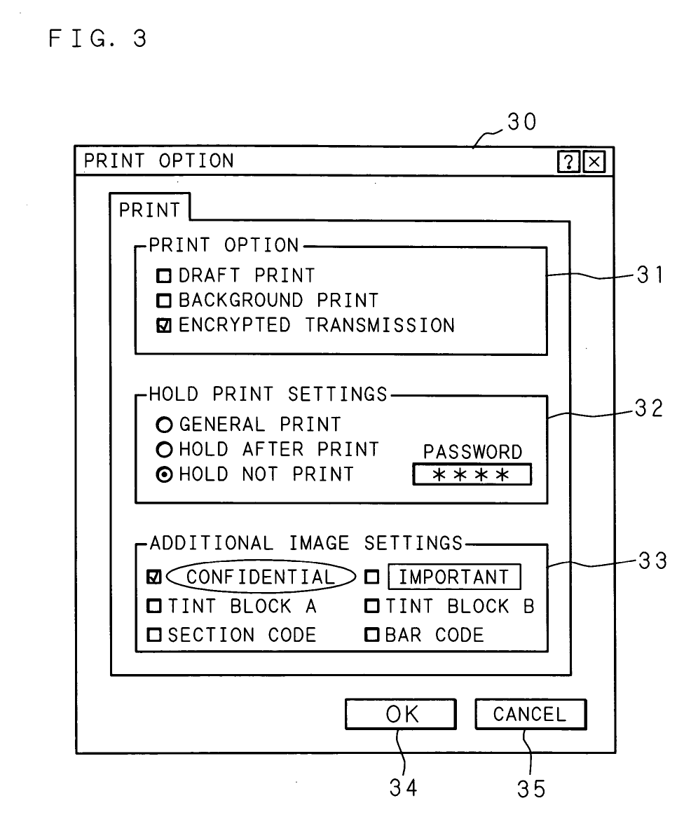

FIG. 3 is a schematic view showing an example of the option setting screen. When the option button 26 on the print setting screen 20 is switched on, the option setting screen 30 appears for selecting any optional action of the printing. The option setting screen 30 displays an option setting dialog box 31 for determining yes or no of draft printing, background printing, and encrypted data transmission, a hold print setting dialog box 32 for determining items of the hold printing, and an additional image setting dialog box 33 for determining items of the additional image printing. Provided beneath the additional image setting dialog box 33 are an execution button 34 and a cancel button 35. When the execution button 34 is switched on, a printing job specified by the settings entered in the setting dialog boxes 31 to 33 is produced. When the cancel button 35 is switched on, the settings on the option setting screen 30 are canceled and the screen returns back to the print setting screen 20.

The option setting dialog box 31 includes check blanks for draft printing, background printing, and encrypted data transmission. When the check blanks are clicked, their corresponding action is carried out.

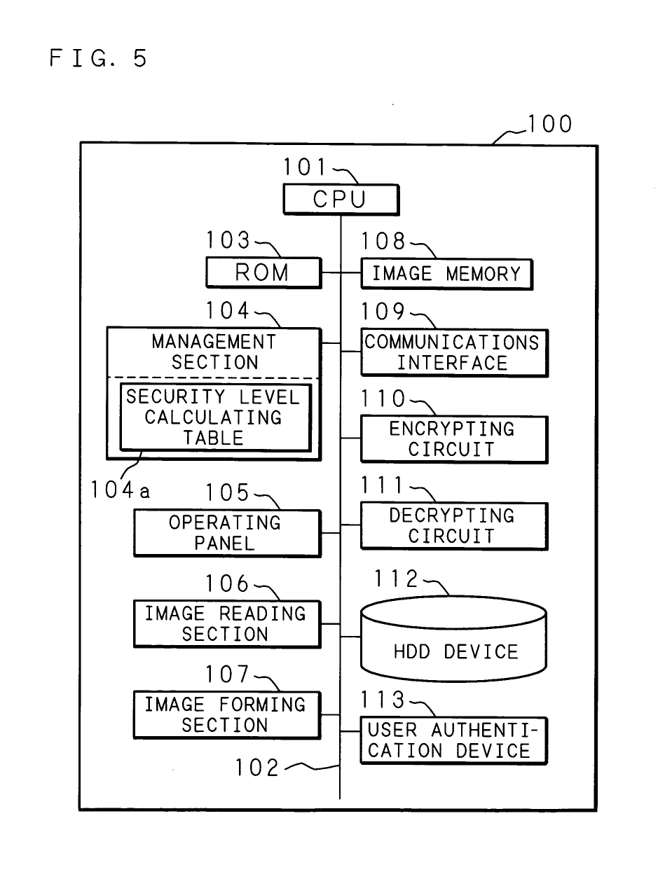

The hold print setting dialog box 32 is provided for setting the timing of starting the printing action. When a check blank for “general print” is clicked, its data of the printing job is transferred to the image forming apparatus 100. Upon receiving the printing job, the image forming apparatus 100 starts the process of general print. When a check blank for “hold after print” is clicked, its data of the printing job is transferred to the image forming apparatus 100. Upon receiving the printing job, the image forming apparatus 100 starts the action of printing and then saves the image data in an HDD 112 (See FIG. 5). When a check blank for “hold not print” is clicked, its data of the printing job is transferred to the image forming apparatus 100. Upon receiving the printing job, the image forming apparatus 100 remains not conducting the action of printing but starts the printing action only when a predetermined password is entered.

The additional image setting dialog box 33 is provided for selectively determining an extra image data to be added to the image data produced by the user. When check blanks are clicked, their corresponding options are added to the image data. For example, when one of the check blanks at the uppermost is clicked for “confidential” or “important”, its corresponding watermark can be printed down as an additional image data. When one of the check blanks at the middle is clicked for tint block “A” or “B”, its corresponding marking can be printed down. When one of the check blanks at the lowermost is clicked for “section code” or “bar code”, its corresponding code can be printed down.

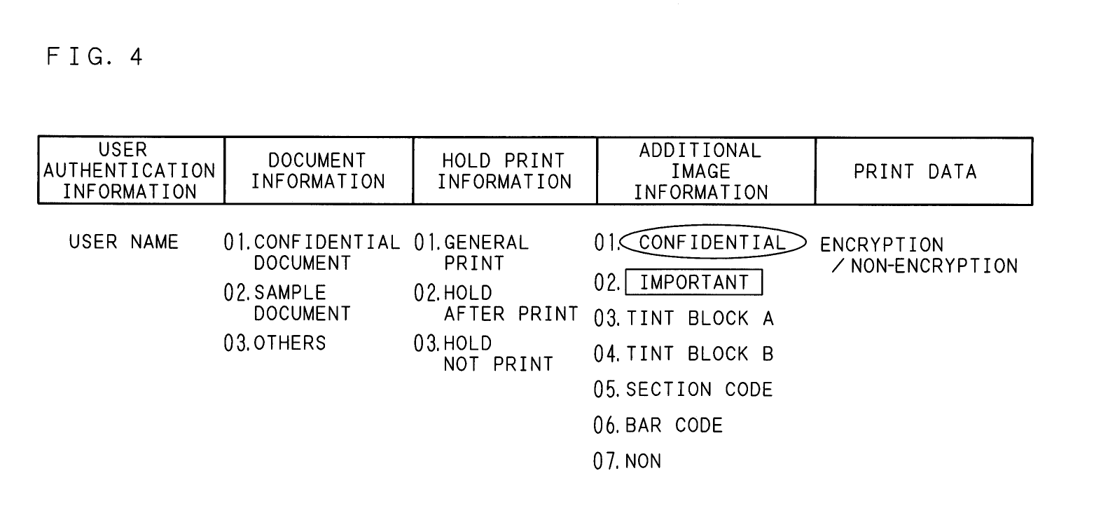

FIG. 4 is a concept view showing the detail of the print job generated by the printer driver. The printing job determined by the print driver consists mainly of a printing data and its attribute data including the user authentication information, the document information, the hold print information, and the additional image information. The user authentication information is entered from the user identification peripheral 201 and may contain the name, status, and section of the user. The document information indicates a type of document as is specified with a flag. For example, “01” of the flag denotes that the document is of a confidential mode while “02” represents a sample mode. The hold print information is also flagged as specified by the settings in the hold print setting dialog box 32 on the option setting screen 30. More particularly, when the hold print information is flagged at “01”, the general printing is executed. When “02”, the holding is carried out after the printing. When “03”, the holding only is carried out with no action of the printing. The additional image information indicates with a flag a type of the additional image data attached to the image data at the image forming apparatus 100. For example, when the flag is “01”, the additional image is a watermark of “confidential”. When the flag is “03”, the tint block of B pattern is printed down as an additional image. The other types of the additional image information are similarly indicated by the flag. The printing data is written in the page description language (PDL). When the encrypted data transmission is selected on the option setting screen 30, the printing data is encrypted and can be decoded at the image forming apparatus 100.

FIG. 5 is a block diagram showing the internal structure of the image forming apparatus 100. The image forming apparatus 100 includes a CPU 101. In action, the CPU 101 operates a control program stored in and read from a ROM 103 for actuating a group of hardware components connected over a bus 102 as the image processing apparatus of the present invention.

A management section 104 comprises a set of non-volatile, rewritable memories for storage of various data about the action of the hardware components as well as the conditions of the apparatus and is arranged to periodically monitor the action of the hardware components and update the data stored in the memories. The management section 104 also includes a security level calculating table 104a for calculating the security level of each image to be released corresponding to the printing job. The security level calculating table 104a will be described later in more detail.

An operating panel 105 comprises an operator including an array of hardware keys and a display including a liquid crystal display panel. It is arranged for switching the action of the hardware components, receiving commands of the user, including a startup of reading the original, and displaying various data to be viewed by the user.

An image reading section 106 comprises a light source for emitting a beam of light for scanning the original, an image sensor such as a CCD array, and an AD converter (not shown). In action, the image reading section 106 develops on the image sensor and converts an optical image of the original placed at the readout position into an analog electric signal-which is then converted into a digital signal by an AD converter. The image reading section 106 finally subjects the digital signal to correcting processes for eliminating unwanted artifacts derived from the optical characteristics of the light source during the scanning and the sensitivity inuniformity of the image sensor, hence forming the image data of a digital form.

An image forming section 107 comprises a charger for charging a photosensitive drum with a desired potential, a laser writer for emitting a laser beam to develop a static latent image of the image data on the photosensitive drum, a developer for feeding the latent image on the photosensitive drum with an amount of toner to have a toner image, and a transfer roll for transferring the toner image from the photosensitive drum to a sheet of paper (which all are not shown). In brief, the image of the original is printed down on a sheet of paper by an electronic photographic technology. Although the image forming section 107 is of an electronic photographic type using the laser writer the embodiment, it may be of any applicable type such as ink jet, thermal transfer, or sublimation type with equal success.

An image memory 108 is a semiconductor memory for temporarily saving an image data received from the image reading section 106, an image data reconstructed according to the printing job received from a communications interface 109, and an image data read out from an HDD 112. In response to a command from the CPU 101, the image data temporarily saved in the image memory 108 is transferred to a destination determined by the printing job. More specifically, when the printing down on a sheet of paper is commanded, the image data is received by the image forming section 107. When the transfer is commanded, the image data is transmitted through the communications interface 109. When the saving is commanded, the image data is received by the HDD 112.

The communications interface 109 includes a network terminal circuit conforming to the standard of the communications network N and is arranged to receive the printing job from each of the data processing terminals 200 connected over the communications network N and supply the data processing terminals 200 with relevant data. In case that the image forming apparatus 100 is used as a network scanner, the image of an original produced by its image reading section 106 is transferred from the communications interface 109 to desired one of the data processing terminals 200. The communications interface 109 controls the transmission and reception of various data.

An encrypting circuit 110 comprises an input buffer for receiving the data to be encrypted, an arithmetic operator for subjecting the data received at the input buffer to an arithmetic operation using a desired encryption algorithm, and an output buffer for holding a result of the arithmetic operation received from the arithmetic operation. The encryption algorithm may be of the advanced encryption standard (AES). In action, the data to be encrypted is received at the input buffer, subjected to the arithmetic operation, and then written in the output buffer after the end of the encryption. The data is then read out from the output buffer by the action of the CPU 101 in the image forming apparatus 100 before released from the encrypting circuit 110.

A decrypting circuit 111 is substantially identical in the arrangement to the encrypting circuit 110 as comprising an input buffer for receiving the data to be decoded, an arithmetic operator for subjecting the data to an arithmetic operation using a desired decoding algorithm, and an output buffer for holding a result of the arithmetic operation. In action, the data to be decoded is received at the input buffer, subjected to the arithmetic operation, and then written in the output buffer after the end of the decoding process. The decoded data is then read out from the output buffer by the action of the CPU 101 in the image forming apparatus 100 before released from the decrypting circuit 111.

The HDD 112 includes a magnetic recording medium of a disk shape where a part of its storage area acts as a data area for saving the image data. The image data can be read out from the data area of the HDD 112 when a command is received from the operating panel 105 or the data processing terminal 200 via the communications interface 109. This allows the image data saved in the data area to be arbitrarily used for repeating the printing action even if the previous action of the printing fails to be completed or produces a less number of prints.

A user authentication device 113 is identical in the arrangement to the user identification peripheral 201 in the data processing terminal 200 and includes a reader for reading the authentication information of a user from the IC card assigned to the user. While the printing action is conducted by the image forming apparatus 100 using a copy function, it can be controlled as well as the requirements of the printing job at a desired level of the security determined by the authentication information of the user which is entered from the user authentication device 113.

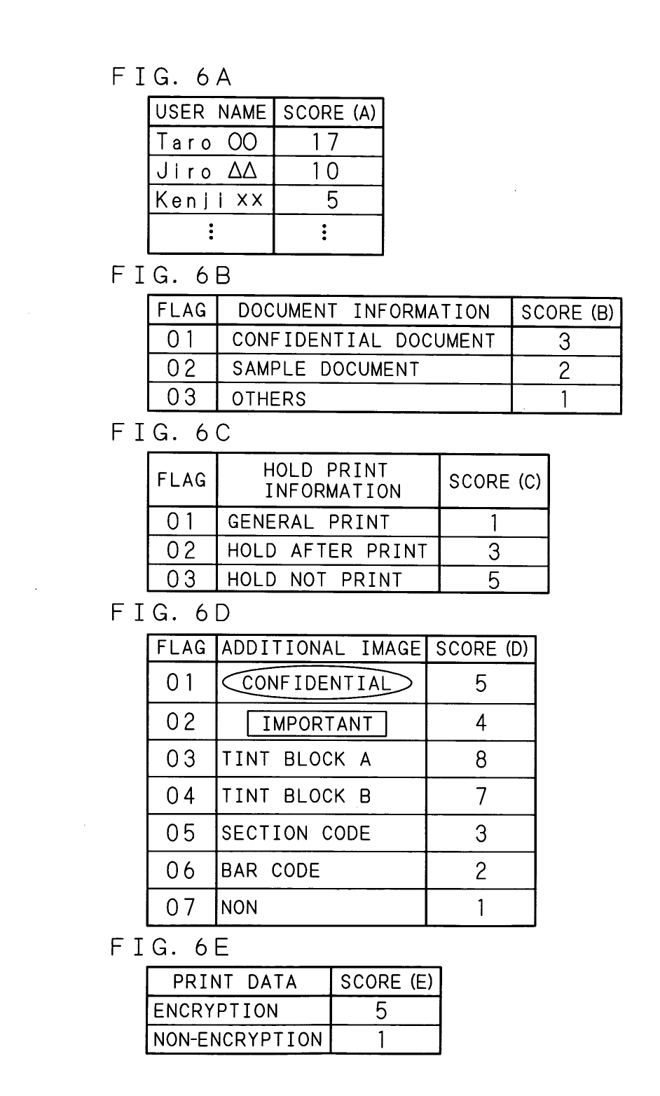

FIGS. 6A to 6E are diagrams showing an example of the security level calculating table 104a stored in the management section 104. In this embodiment, the level of the secrecy of each image to be released according to the printing job is calculated with the security level calculating table 104a shown in FIGS. 6A to 6E. FIG. 6A indicates a list of reference numerals for the user authentication information. It is assumed in the list that Mr. Taro OO is ranked with 17 as a reference numeral for determining the level of the secrecy. Also, Mr. Jiro ((is ranked with 10 and Mr. Kenji XX is ranked with 5. The reference numeral designated for ranking the user authentication information will be termed as score (A) hereinafter.

Similarly, FIG. 6B indicates a list of reference numerals for the document information where the document types of “confidential mode”, “sample mode”, and “other mode” are denoted by different reference numerals. The reference numeral designated for ranking the document information will be termed as score (B) hereinafter. FIG. 6C indicates a list of reference numerals for the hold print information where the selections of “general print”, “hold after print”, and “hold not print” are denoted by different reference numerals. The reference numeral designated for ranking the hold print information will be termed as score (C) hereinafter. FIG. 6D indicates a list of reference numerals for the additional image information where the additional images of “confidential”, “important”, “tint block A” and so on are denoted by different reference numerals. The reference numeral designated for ranking the additional image information will be termed as score (D) hereinafter. FIG. 6E indicates a list of reference numerals for determining whether or not the printing data is encrypted. In particular, 5 represents the data encrypted while 1 represents no encryption. The reference numeral designated will be termed as score (E) hereinafter.

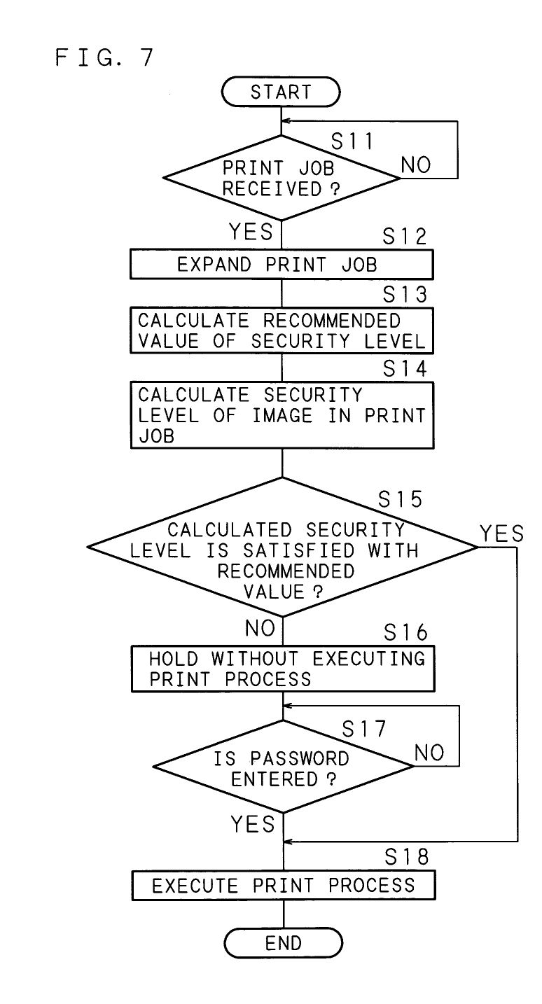

FIG. 7 is a flowchart explaining the steps of a process to be executed by the image forming apparatus 100. The CPU 101 in the image forming apparatus 100 monitors the communications interface 109 and judges whether a printing job is received or not (Step S11). When the printing job is not received (No at S11), the action stands by until the printing job is received. When the printing job is received (Yes at S11), it is expanded to identify the printing data and its attribute data (Step S12). When the printing data is encrypted, it is decoded by the decrypting circuit 111.

This is followed by calculating a recommended value of the security from the attribute data (Step S13). In this embodiment, the recommended value of the security is determined from the user authentication information and the document information. More specifically, the score (A) ranking the user authentication information and the score (B) ranking the document information are read out from the security level calculating table 104a and summed up to determine the recommended value of the security.

Then, the security level of an image to be printed according to the printing job is calculated (Step S14). In this embodiment, the security level of the image to be printed is determined from a combination of the hold print information, the additional image information, and the encryption data. More specifically, the score (C) ranking the hold print information, the score (D) ranking the additional image information, and the score (E) ranking the encryption data are read out from the security level calculating table 104a and summed up to determine the security level.

The security level calculated at Step S14 is then compared with the recommended value of the security calculated at Step S13 for judging whether or not the security level is satisfied with the recommended value (Step S15).

When the security level fails to conform to the recommended value (No at Step S15), the holding action is carried out without executing the printing process regardless of the setting of the hold print information (Step S16). More particularly, the printing data remains held in the HDD 112 until a correct password is entered from the operating panel 105. It is then examined by the CPU 101 whether or not the password has been entered from the operating panel 105 (Step S17). When the password is not entered (No at S17), the operation stands by until the password is entered. When the password has been entered (Yes at S17), the printing data is read out from the HDD 112 and subjected to the printing process (Step S18). When it is judged that the security level is satisfied with the recommended value (Yes at S15), the printing action is carried out according to the printing job (Step S18).

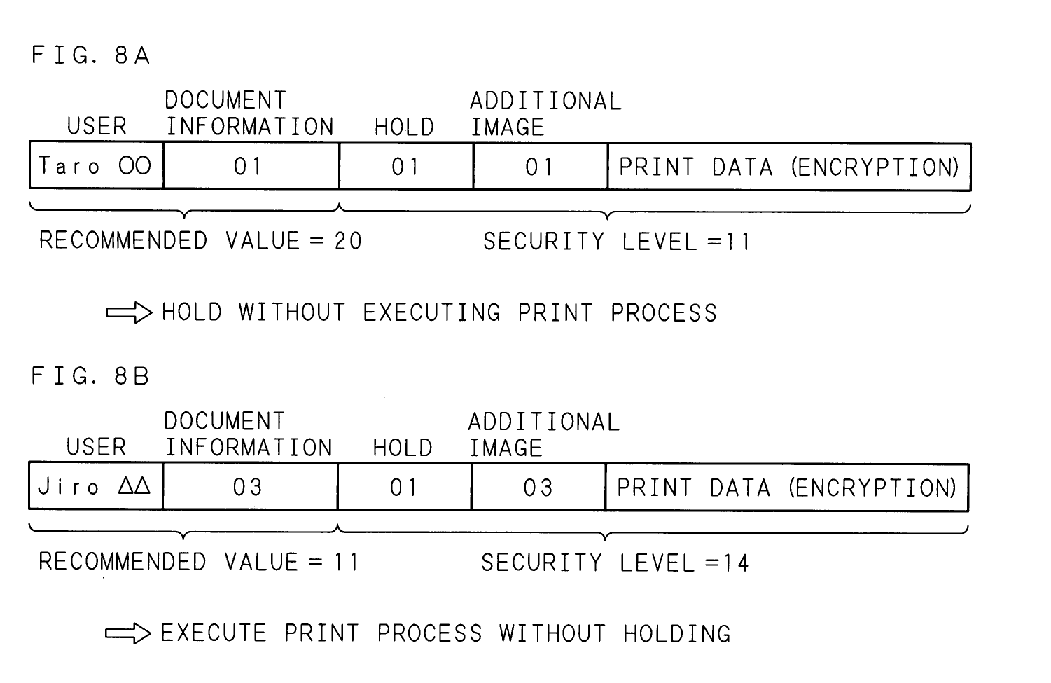

FIGS. 8A and 8B are explanatory diagrams explaining examples for calculating the security levels. In the printing job shown in FIG. 8A, the user authentication information is specified by “Taro OO” and the document information is of “confidential mode”. As apparent from the security level calculating table 104a shown in FIGS. 6A to 6E, the score (A) is 17 and the score (B) is 3. Accordingly, the recommended value of the security is 20 for the printing job. Meanwhile, the printing job indicates that the hold print information is “general print” and the additional image information is of “confidential mode” while the printing data is encrypted. As the scores (C) to (E) are summed up, the security level is 11. It is then apparent that the security level of the printing job shown in FIG. 8A fails to conform to the recommended value. As a result, the holding action is carried out without executing the printing process regardless of the setting of the hold print information because the security has to be maintained.

In the printing job shown in FIG. 8B, the user authentication information is specified by “Jiro ((” and the document information is of “other mode”. As apparent from the security level calculating table 104a shown in FIGS. 6A to 6E, the score (A) is 10 and the score (B) is 1. Accordingly, the recommended value of the security is 11 for the printing job shown in FIG. 8B. Meanwhile, the printing job indicates that the hold print information is “general print” and the additional image information is “tint block pattern A” while the printing data is encrypted. As summed up, the security level is 14. It is apparent that the security level of the printing job shown in FIG. 8B successfully conforms to the recommended value. As a result, the printing action is carried out according to the printing job.

In this embodiment, when the security level fails to conform to the recommended value, the printing job is held but not executed until a correct password is entered for maintaining the security. Since the image forming apparatus 100 enables to maintain the security with the use of the additional image information and the encryption of the printing data, it may optionally carry out its desired action regardless of the calculated security level not conforming to the recommended value.

Embodiment 2

The previous embodiment allows the printing action to be carried out depending on the result of the comparison between the calculated security level and the recommended value defined by the printing job. Alternatively, the actions to be carried out may be predetermined in relation to different security levels respectively. This allows the action to be executed corresponding to the security level calculated. The system and its image forming apparatus 100 in this embodiment are identical to those of Embodiment 1 and will be explained in no more detail.

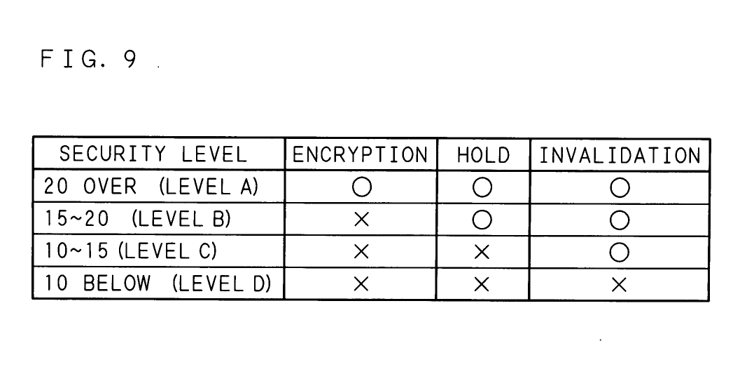

FIG. 9 is a diagram showing a list of the processes to be executed depends on the calculated security levels. In this embodiment, the security level is calculated from all the data in each printing job. More particularly, the sum of the scores (A) to (E) shown in FIGS. 6A to 6E is used for calculating the security level. The table shown in FIG. 9 indicates that, when the security level is higher than 20 (referred to as level A), the image data in the printing data is encrypted and held but not subjected to the printing action and after the printing action, is invalidated. When the security level is between 15 and 20 (referred to as level B), the image data in the printing data is held but not subjected to the printing action and after the printing process, is invalidated. When the security level is between 10 and 15 (referred to as level C), the image data after the printing action is invalidated. When the security level is lower than 10 (referred to as level D), no security action is made.

The table is saved in the management section 104 of the image forming apparatus 100 and used for determining the process corresponding to the different security levels which are calculated from the security level calculating table 104a.

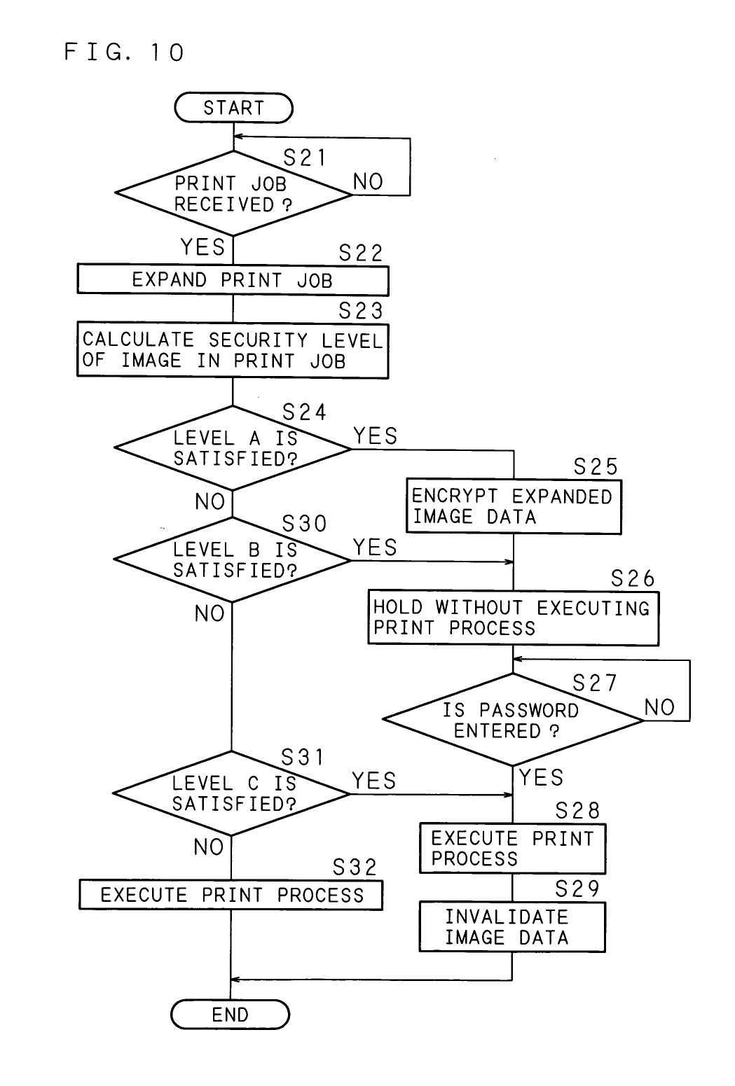

FIG. 10 is a flowchart explaining the steps of a process to be executed by the image forming apparatus 100. The CPU 101 in the image forming apparatus 100 monitors the communications interface 109 and judges whether a printing job is received or not (Step S21). When the printing job is not received (No at S21), the action stands by until the printing job is received. When the printing job is received (Yes at S21), it is expanded to identify the printing data and its attribute data (Step S22). When the printing data is encrypted, it is decoded by the decrypting circuit 111.

This is followed by calculating the security level of an image to be printed according to the printing job (Step S23). In this embodiment, the security level is determined from the user authentication information, the document information, the hold print information, the additional image information, and the encryption data.

It is then examined whether or not the security level is satisfied with the level A (Step S24). When the security level satisfied with the level A (Yes at S24), the image data in the printing data is transferred to the encrypting circuit 110 for encryption (Step S25) and its encrypted form is saved in the HDD 112. The printing action is held but not executed until a correct password is entered (Step S26). It is then examined whether or not the password is entered from the operating panel 105 (Step S27). When the password is not entered (No at S27), the operation is held until the password is entered. When it is judged that the password is entered (Yes at S27), the encrypted image data is read out from the HDD 112, decoded by the decrypting circuit 111, and transferred to the image forming section 107 where it is subjected to the printing action (Step S28). When the printing action has been completed, the image data saved in the HDD 112 is invalidated (Step S29). The invalidation of the image data may be conducted by writing one or more times a zeroes or random data over the image data which can thus be deleted and not reproduced.

When it is judged at Step S24 that the security level fails to conform to the level A (No at S24), the procedure goes to Step S30 where it is examined whether or not the security level is satisfied with the level B. When the security level is satisfied with the level B (Yes at S30), the image data in the printing data is saved in the HDD 112 but not subjected to the printing action (Step S26). When the password is entered (Yes at S27), the image data is read out from the HDD 112 and transferred to the image forming section 107 where it is subjected to the printing action (Step S28). This is followed by writing a zeroes or random data over the image data saved in the HDD 112 for invalidation of the image data (S29).

When it is judged at S30 that the security level fails to conform to the level B (No at S30), the procedure goes to S31 where it is examined whether or not the security level is satisfied with the level C. When the security level satisfied with the level C (Yes at S31), the image data in the printing data is temporarily saved in the HDD 112 and subjected to the printing action (Step S28). This is followed by writing a zeroes or random data over the image data saved in the HDD 112 for invalidation of the image data (S29).

When it is judged at Step S31 that the security level fails to conform to the level C (No at S31) or the security level is satisfied with the level D, the procedure goes to Step S32 where the image data in the printing data is directly subjected to the printing action without temporarily saved in the HDD 112.

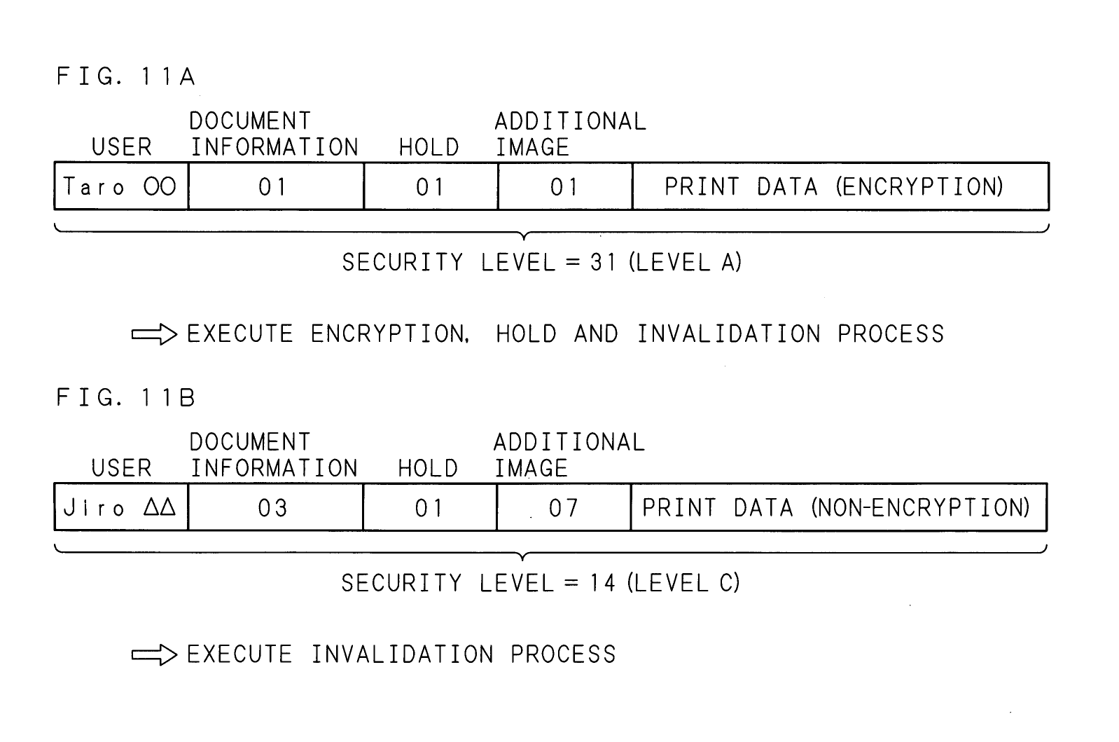

FIGS. 11A and 11B are explanatory diagrams explaining examples for calculating the security levels. In the printing job shown in FIG. 11A, the user authentication information is specified by “Taro OO” and the document information is of “confidential mode”. Also, the printing job indicates that the hold print information is “general print” and the additional image information is “confidential” while the printing data is encrypted. As calculated with the security level calculating table 104a shown in FIGS. 6A to 6E, the security level of the image defined by the printing job is 31. It is then apparent that the security level is satisfied with the level A in the table shown in FIG. 9. As a result, the image data is encrypted and held but not subjected to the printing action and after the printing action, is invalidated.

In the printing job shown in FIG. 11B, the user authentication information is specified by “Jiro ((” and the document information is of “other mode”. Also, the hold print information is “general print” and the additional image information is “non” while the printing data is not encrypted. As calculated with the security level calculating table 104a shown in FIGS. 6A to 6E, the security level of the image defined by the printing job is 14. It is then apparent that the security level is satisfied with the level C in the table shown in FIG. 9. As a result, the image data is not encrypted and held but directly subjected to the printing action and after the printing action, is invalidated.

In this embodiment, the user authentication device 201 is used for providing the data processing terminal 200 with the user authentication information. The entry of the user authentication information is not limited to the user authentication device 201 but may be carried out by the data processing terminal 200 which displays a blank for entering the user authentication information on the print setting screen 20 during the setting of the printing job and allows the entry of the user authentication information from its operating panel. It would also be understood that the recording medium for carrying the user authentication information is not limited to an IC card or a card memory. Alternatively, the user authentication information may be received over a radio communications system, an infrared ray communications system, or a Blue-tooth system using mobile telephones, personal data assistants (PDAs), and wireless tag devices.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image processing method comprising the steps of:
receiving image data and reference data for processing the image data;
judging a level of secrecy of the image data to be processed, on the basis of the received reference data;
determining a process to be executed on the basis of a result of the judgment; and
executing the process.

2. An image processing apparatus comprising:
a controller capable of performing operations of:
receiving image data and reference data for processing the image data;
judging a level of secrecy of the image data to be processed, on the basis of the received reference data;
determining a process to be executed on the basis of a result of the judgment; and
executing the process.

3. The image processing apparatus according to claim 2, wherein the reference data indicates whether or not the image data is encrypted.

4. The image processing apparatus according to claim 2, wherein
the controller is further capable of performing an operation of combining the received image data with prescribed image data, and
the reference data indicates whether or not the image data is to be combined with the prescribed image data.

5. The image processing apparatus according to claim 2, wherein the reference data indicates information about a user.

6. The image processing apparatus according to claim 2, wherein the controller is further capable of performing an operation of executing an invalidation process on the image data, when it is judged that the level of secrecy of the image data is high.

7. The image processing apparatus according to claim 2, wherein the controller is further capable of performing an operation of executing an encryption process on the image data, when it is judged that the level of secrecy of the image data is high.

8. The image processing apparatus according to claim 2, wherein the controller is further capable of performing operations of:
receiving user data;
identifying a user from the received user data; and
pausing the process until the user is identified, when it is judged that the level of secrecy of the image data is high.

9. An image processing apparatus comprising:
a controller capable of performing operations of:
receiving image data and reference data for processing the image data;
judging a level of secrecy of the image data on the basis of the received image data and reference data;
determining a process to be executed on the basis of a result of the judgment; and
executing the process.

10. An image processing apparatus comprising:
means for receiving image data and reference data for processing the image data;
means for judging a level of secrecy of the image data to be processed, on the basis of the received reference data;
means for determining a process to be executed on the basis of a result of the judgment; and
means for executing the process.

11. The image processing apparatus according to claim 10, wherein the reference data indicates whether or not image data is encrypted.

12. The image processing apparatus according to claim 10, further comprising:
means for combining the received image data with prescribed image data, and wherein
the reference data indicates whether or not the image data is to be combined with the prescribed image data.

13. The image processing apparatus according to claim 10, wherein the reference data indicates information data about a user.

14. The image processing apparatus according to claim 10, wherein the invalidation process is executed on the image data, when it is judged that the level of secrecy of the image data is high.

15. The image processing apparatus according to claim 10, wherein the encryption process is executed on the image data, when it is judged that the level of secrecy of the image data is high.

16. The image processing apparatus according to claim 10, further comprising:
means for receiving user data; and
means for identifying a user from the received user data, wherein
the process is paused until the user is identified, when it is judged that the level of secrecy of the image data is high.

17. An image processing apparatus comprising:
means for receiving image data and reference data for processing the image data;
means for judging the level of secrecy of the image data on the basis of the received image data and reference data;
means for determining a process to be executed on the basis of a result of the judgment; and
means for executing the process.
